(19) United States
(12) Patent Application Publication
(10) Pub. No.: US 2015/0074101 A1
(43) Pub. Date: Mar. 12, 2015

(54) SMART SEARCH REFINEMENT

(71) Applicant: Microsoft Corporation, Redmond, WA (US)

(72) Inventors: Helge G. Solheim, Oslo (NO); Jørgen V. Iversen, Oslo (NO); Alexander J. Pope, Oslo (NO); Sverre K. Tennøe, Oslo (NO); Michael James Taylor, Cambridge (GB)

(73) Assignee: Microsoft Corporation, Redmond, WA (US)

(21) Appl. No.: 14/022,894

(22) Filed: Sep. 10, 2013

(51) Int. Cl. G06F 17/30

(52) U.S. Cl. CPC G06F 17/30867; G06F 17/30672
USPC 707/732

(57) ABSTRACT

An initial search request can be received. At least a portion of a set of initial search results can be presented in response to receiving the initial search request. The initial search results can include representations of searchable items that are responsive to the initial search request, where each of the searchable items can be a computer-readable data structure. A search refinement indicator can also be presented with the initial search results. User input can be received selecting the refinement indicator. In response, at least a portion of a set of refined search results can be presented. The refined search results can be a subset of the initial search results representing searchable items that meet requirements including a set of pre-defined smart refinement requirements of the refinement indicator.

### BACKGROUND

When searching, users of search engines often want to narrow down initial search results. This is often done by adding more terms to an existing query. Additionally, some search systems present users with refinement indicators that can be selected to refine the initial search results according to pre-defined refinement requirements. The requirements of such existing refiners are simple one-dimensional, single property key-value pairs. Thus, each refiner refines on a single aspect of a searchable item.

### SUMMARY

The tools and techniques discussed herein relate to smart search refiners that can be selected to produce refined search results. These smart search refiners provide for refinement beyond refiners that refine with requirements that are only one-dimensional, single property key-value pairs.

For example, the refiners may include a complex query refiner that invokes a complex query requirement set. The complex query requirement set can specify requirements for multiple different aspects of a searchable item that are to be met for a corresponding searchable item representation to be included in the refined search results. As used herein, a searchable item is a computer-readable data structure that is subject to searching, such as a Web page, a word processing document, a slide presentation, a spreadsheet document, an image file, a user profile, a database record, and/or some other type of item that can be searched. As used herein an aspect of a searchable item is a field of that searchable item that is separated from other fields of the searchable item. For example, each field may include attributes such as a field title and a field value. Examples of different aspects include a body field, a title field, an author field, a date created field, a date last modified field, etc.

As another example, the refiners may include a user action refiner, which can invoke a user action requirement set. The user action requirement set can specify at least one requirement for a user action set comprising one or more user actions on a searchable item, and the user action requirement set can further specify at least one relationship of the user action set to a user profile for a corresponding searchable item representation to be included in the refined search results. The relationship may be a direct relationship such as where the user action set is performed at least in part by the user profile from which a subject search request is received; or an indirect relationship such as where the user action set is performed at least in part by a second user profile that has a social relationship with the user profile from which the search request is received, with the social relationship meeting a predetermined set of one or more social relationship criteria.

As another example, the refiners may include a user profile relationship refiner that invokes a user profile relationship requirement set. The user profile relationship requirement set can specify at least one requirement for a user profile relationship set comprising one or more relationships (such as social relationships) between the user profile from which the search request is received and one or more other user profiles for one or more searchable item representations corresponding to one or more searchable items related to those one or more other user profiles to be included in the refined search results.

As another example, the refiners may include an excluded item refiner that invokes an excluded item requirement set comprising one or more identifiers of one or more specific searchable items whose representations are to be excluded from the refined search results.

As another example, the refiners may include an included item refiner that invokes an included item requirement set comprising one or more identifiers of one or more specific searchable items whose representations are to be included in the refined search results (if they were included in the initial results that are being refined).

As another example, the refiners may include combination refiners that invoke any combination of two or more of a complex query requirement set, a user action requirement set, a user profile relationship requirement set, an excluded item requirement set, and an included item requirement set

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of a search environment implementing smart search refinement.

FIG. 3 is a block diagram of an architecture for a search system implementing smart search refinement.

FIG. 4 is an illustration of a search user interface for smart search refinement.

FIG. 5 is an illustration of another search user interface for smart search refinement.

FIG. 6 is an illustration of yet another search user interface for smart search refinement.

FIG. 7 is a flowchart illustrating a technique for smart search refinement.

FIG. 8 is a flowchart illustrating another technique for smart search refinement.

### DETAILED DESCRIPTION

Embodiments described herein are directed to techniques and tools for improved search refinement. Such improvements may result from the use of various techniques and tools separately or in combination.

Such techniques and tools may include providing smart search refiners. For example, each such smart refiner may be selected by a single user input gesture (e.g., a single mouse click, single touch on a touch screen, single voice command, etc.) directed at a refinement indicator. Such an input gesture can result in a system automatically responding by performing a refinement of an existing query and presenting refined results that restrict the query in one or more ways that go beyond a single key-value pair restriction.

In one embodiment, a search system can provide a smart refiner list with search refinement indicators that represent each refiner with an understandable and intuitive title. Each smart refiner can be more than a single key-value pair restriction to the existing query. For example, a smart refiner can be a pre-defined complex query that searches on multiple different aspects of a searchable item and/or one or more pre-defined explicit lists of specific searchable items to be included or excluded from refined search results.

A refinement indicator (e.g., a displayed visual indicator such as a label, icon, picture, etc.) can intuitively identify a set of searchable items which can be used to intersect with the current result set (i.e. “refine” the current result set or the current query). The refiner can be a complex query, which can search on multiple aspects of a searchable item. Moreover, the refiners may not be limited to just complex queries. For example, the refiner could be a user curated list of documents and/or other searchable items, or a combination of a query and one add-to-that-result-list of specific searchable items to add, and/or a remove-from-that-list of specific searchable items to remove from the list resulting from the query. The smart refiners may query not only a “regular inverted index”, or searchable item index based on a searchable item corpus, but could also query a graph index such as a social index or activity index, which can define relationships between user profiles, and relationships between user profiles and activities performed by these user profiles to other user profiles or to searchable items in the searchable item index.

What refiners to show may be dynamic depending on the query and result set in question. For example, sometimes it may make sense to show one intelligent refiner for “Blue Yonder”, other times that intelligent refiner may not be relevant. For example, a refiner may not be shown if it would not further limit the current search result set, or if it would result in no searchable items from the current search result set that would meet the requirements of the refiner.

Accordingly, one or more substantial technical benefits can be realized from the search refinement tools and techniques described herein. For example, these techniques can provide for more efficient and effective ways for a computer search system to slice a current search result set and find the searchable items sought by the user.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

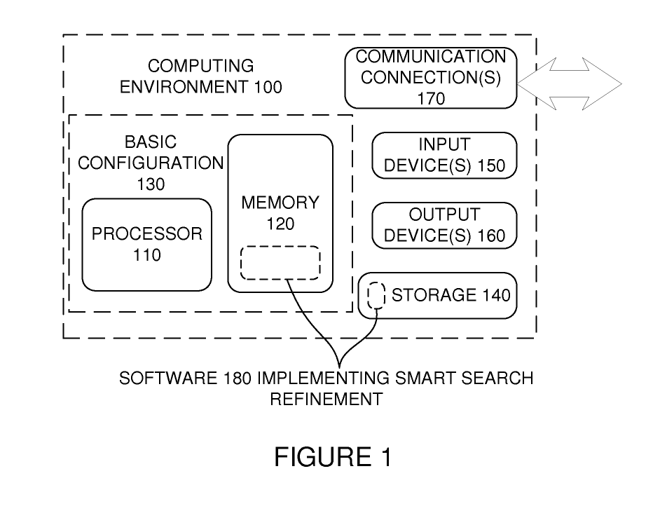

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment (100) in which one or more of the described embodiments may be implemented. For example, one or more such computing environments can be used as a search service, a searchable item repository, and/or a search client. Generally, various different general purpose or special purpose computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, various illustrated hardware-based computer components will be discussed. As will be discussed, these hardware components may store and/or execute software. The computing environment (100) includes at least one processing unit or processor (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing smart search refinement. An implementation of smart search refinement may involve all or part of the activities of the processor (110) and memory (120) being embodied in hardware logic as an alternative to or in addition to the software (180).

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as flash drives, magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be one or more of various different input devices. For example, the input device(s) (150) may include a user device such as a mouse, keyboard, trackball, etc. The input device(s) (150) may implement one or more natural user interface techniques, such as speech recognition, touch and stylus recognition, recognition of gestures in contact with the input device(s) (150) and adjacent to the input device(s) (150), recognition of air gestures, head and eye tracking, voice and speech recognition, sensing user brain activity (e.g., using EEG and related methods), and machine intelligence (e.g., using machine intelligence to understand user intentions and goals). As other examples, the input device(s) (150) may include a scanning device; a network adapter; a CD/DVD reader; or another device that provides input to the computing environment (100). The output device(s) (160) may be a display, printer, speaker, CD/DVD-writer, network adapter, or another device that provides output from the computing environment (100). The input device(s) (150) and output device(s) (160) may be incorporated in a single system or device, such as a touch screen or a virtual reality system.

The communication connection(s) (170) enable communication over a communication medium to another computing entity. Additionally, functionality of the components of the computing environment (100) may be implemented in a single computing machine or in multiple computing machines that are able to communicate over communication connections. Thus, the computing environment (100) may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Search System and Environment

A. General Search Environment

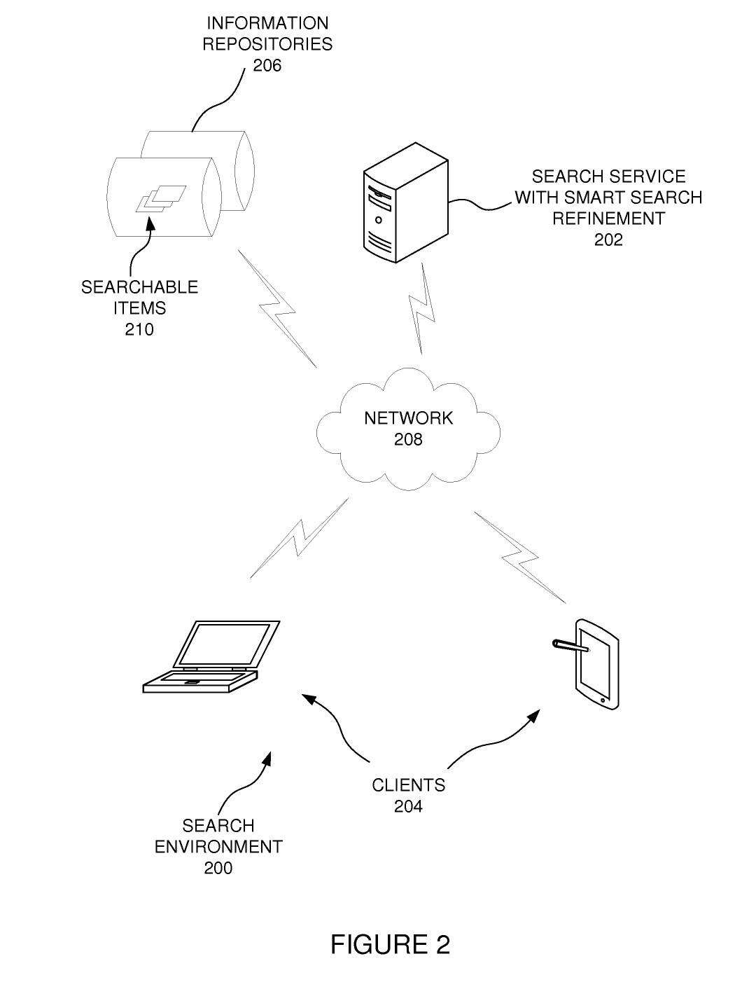

FIG. 2 is a schematic diagram of a search system or environment (200) in conjunction with which one or more of the described embodiments may be implemented. The search environment (200) can include a search service (202) with smart search refinement. The search service (202) can be communicatively coupled to one or more clients (204) and/or one or more information repositories (206), such as via a computer network (208). For example, the search service (202) may be hosted on one or more server computing machines that may communicate over a computer network (such as a global computer network) with the clients (204) hosted on one or more client computing machines. Alternatively, the search service (202) may be located in the same local environment as one or more of the information repositories (206) and/or one or more of the clients (204).

In one example, the information repositories (206) can be used to provide crawled data associated with a number of site collections, sites, farm content, etc. With continuing reference to FIG. 1, the search service (202) can include indexing features used to process any number of searchable items (210) in the information repositories (206), such as web pages, word processing and/or other documents, spreadsheets, music files, picture files, video files, contacts, lists and list items, tasks, calendar entries, digital content of various kinds, metadata, meta-metadata, etc. The search service (202) may include features that may operate to perform operations such as the following: create indexes based on raw textual input and/or return results for queries by using the indexes; receive content from various clients, crawlers, connectors, etc. which can be processed and indexed; and/or parse information including documents and other content to produce a textual output, such as a list of searchable item aspects including document title, document content, body, locations, size, etc. as examples. The search service (202) can also provide smart search refinement, as is discussed in more detail below.

The search service (202) may include a search schema management system (not shown in FIG. 2). The schema management system may provide schema features and functionality, which may be configurable in some examples. The schema management system may be configured to translate user interactions to calls to a schema processing component that operates to persist the schema information in a schema storage component. The schema storage component may be configured to contain a list of searchable item aspects, and for each searchable item aspect define a merge set to which the property belongs, thereby grouping the searchable item aspects and splitting the searchable items into constituent parts.

The search service (202) can interact with the schema management system in part by reading schema information (e.g., merge set information) through an interface to obtain the proper searchable item aspect and query mappings. During query time, the search service (202) can operate to account for multiple merge sets used to manage a search process. In one example implementation, a field splitter feature can be used to examine a received query and send query parts to corresponding indices or index portions corresponding to the merge set(s), using schema and mapping information managed by the schema management system. When the results from each merge set are returned from the indices or index portions, the field splitter feature can operate to generate an overall result set for further result processing. The search service (202) can also be configured to rank the result set, such as by using an algorithm that uses multiple ranking features, as a general search ranking algorithm. Additionally, the search service (202) can provide search refinement indicators with the search results.

Accordingly, the search service (202) may be configured to send the correct information regarding associated searchable item aspects/fields to the proper merge sets according to a configurable schema that is used in part to group aspects of electronic documents, including meta-properties and/or other information into target merge sets. In one example, the search service (202) can use a separate index representation for each merge set according to the types of searchable item aspects being managed. Each searchable item index can include different types of index fields depending on searchable item aspects being managed using the corresponding merge set. Alternatively, a single unitary searchable item index may be used.

B. General Search Service Components

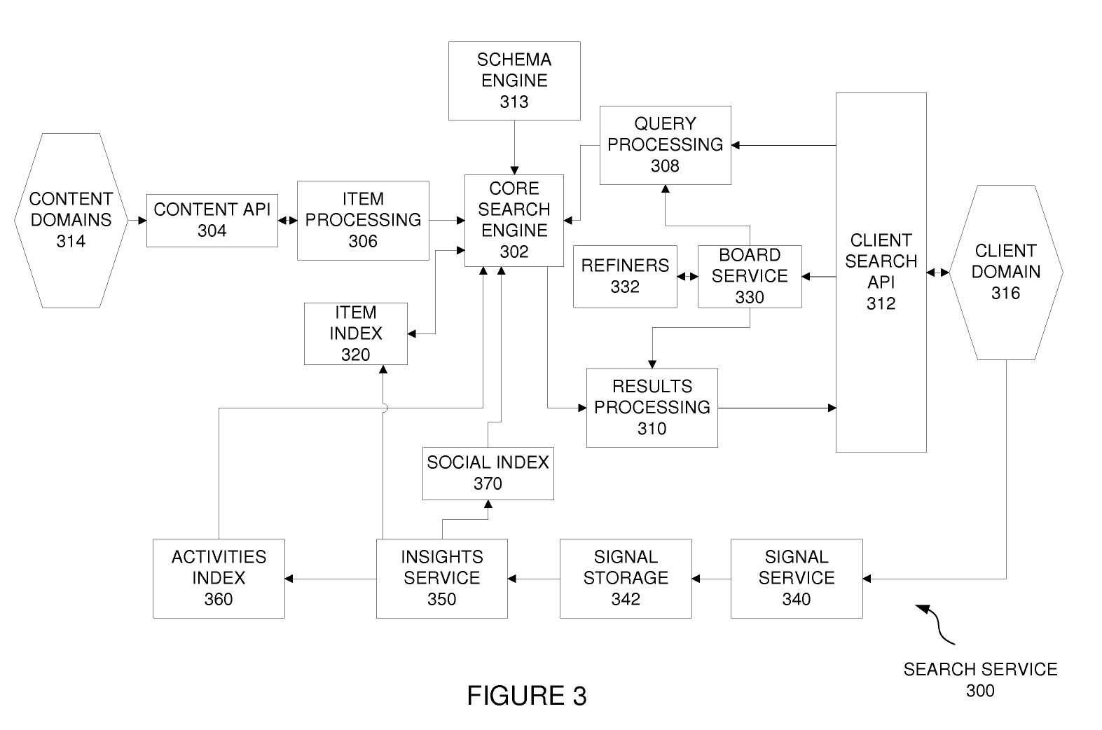

FIG. 3 is a block diagram that depicts components of an example search service or system (300) configured to provide indexing and searching services, which can include smart search refinement. Features of the search service (300) that are used in implementing initial searching will now be discussed, followed by discussions of additional features that are used for smart refiners. However, the features discussed as being used for initial searching may be used for smart refiners and vice versa. As shown in FIG. 3, the search service (300) can include a core search engine (302), a content application programming interface (API) (304), searchable item processing component (306), query processing component (308), a results processing component (310), a client search application programming interface (API) (312), and a schema engine (313).

The search service (300) can include a computing architecture that uses processor(s), memory, hard drive storage, networking, and/or other components, such as those discussed above with reference to FIG. 1. In some embodiments, component features and/or functionalities can be further combined and/or subdivided.

The core search engine (302) can include functionality to populate an item index (320) based on raw textual input and return results for queries by using the item index (320) (which may actually include multiple different indexes that are maintained based on corresponding search merge sets, as discussed above). The content API (304) can be used by various clients, crawlers, connectors, etc. (e.g., content domains (314)) to submit and receive content for subsequent processing and indexing operations. Item processing component (306) can be used to parse documents and other searchable items to produce textual and other output, such as a list of searchable item aspects for example (e.g., document title, document content, body, locations, size, etc.).

The query processing component (308) can operate to analyze raw user input (e.g., query), including improving and/or rewriting a query for execution using the core search engine (302). For example, query processing component (308) can be configured to detect language, correct spelling errors, add synonyms to a query, rewrite abbreviations, etc. The results processing component (310) can operate to process results provided by the core search engine (302) before the results are returned. For example, the core search engine (302) can contain ranking and relevancy algorithms, and the results processing component (310) can contain sorting, filtering, and/or federation (e.g., the results processing component can use data from other data sources such as general search engines, stock exchange data, current weather reports/forecasts or other features used in part to return relevant search results). The client search API (312) can be used by search front-end and other applications (e.g., client domains (316)) to issue queries and retrieve results using the queries.

The search service (300) can be used to provide searching services, including providing a store for partial update support, domain-wide terms, keywords, content types, and/or other data and/or parameters.

C. Search Service Smart Refiner Components

Additional components of the example search service (300) that may be used for smart refiners will now be discussed. For example, the search service (300) can include a board service (330). The board service (330) can manage a set of refiners (332). For example, each refiner (332) can be a data structure that defines a search refinement indicator and a set of smart refinement requirements. The smart refinement requirements can be pre-defined (i.e., the smart refinement requirements are defined without user input being provided to define the refinement requirements after the initial search results are provided). For example, the refinement requirements may be initially defined and/or modified by user input provided to the board service (330) through the client search API (312).

The board service (330) can interact with the query processing component (308) and the results processing component (310). For example, the board service (330) may provide the results processing component (310) with search refinement indicators from the refiners (332) to be provided to the client domain (316) through the client search API (312), along with the initial search results. Additionally, when a user selects such a search refinement indicator in the client domain (316), the board service (330) can provide the query processing component (308) with the search refinement requirements from the corresponding refiner (332). Thus, the query processing component (308) can use the search refinement requirements to provide the core search engine (302) with the query to be performed by that core search engine to actually refine the search results. For example, the query processing component (308) may pass the core search engine (302) a query that intersects the initial query and the refinement requirements, so that returned results will meet both the initial query requirements and the refinement requirements from one or more refiners (332) selected by user input (i.e., by the user input selecting one or more presented search refinement indicators).

The search service (300) can also include components to maintain one or more indexes that can be used by the core search engine (302) when refining search results using the smart search refiners. For example, the search service (300) can include a signal service (340), which can monitor signals, such as signals from the client domain (316). For example, the signals may include activities performed on searchable items and/or activities performed by user profiles. For example, a signal may indicate that a particular user profile has viewed a searchable word processing document. As another example, a signal may indicate that a user profile has accepted a friend request from another user profile on a social network. As yet another example, a signal may indicate that a particular searchable item was presented during a meeting where a list of user profiles are listed as attendees. The signal service (340) may monitor signals from multiple different sources, such as different systems, different user profiles, different computing machines, etc. For example, the signal service (340) may monitor signals from access to searchable items, attendance at meetings, email interactions, social network activities, etc. In so doing, the search service (300) can take measures to protect user privacy, such as limiting access to the results of such signal monitoring, allowing users to opt into or out of such signal monitoring, informing users of such monitoring, etc.

The signal service (340) can process such signals and can store information indicated by the signals in signal storage (342). An insights service (350) may process data from the signal storage (342). For example, the insights service may perform batch processing of raw signals and may populate a social index (370), an activities index (360), the items index (320) and/or other indexes such as other graph indexes with higher-level and aggregate links based on user activities represented by data stored in the signal storage (342). For example, if the signal storage (342) indicates multiple activities where users have viewed a particular searchable item, the insights service (350) may aggregate those views and populate the item index (320) with a representation of a total number of views by a particular group of user profiles (e.g., user profiles within a particular company or a particular department in a company). The insights service (350) may also populate the activities index with indications of the particular views, with the index entries relating each view with the particular searchable item that is viewed and with a particular user profile that is viewing the searchable item. As another example, if activities indicate two or more user profiles participating in common activities (e.g., attending the same meetings, viewing the same documents, etc.), those user profiles may be linked in the social index (370), possibly along with information indicating the number and type of such common activities.

The core search engine (302) can access the indexes (320, 360, and 370) that are populated by the insights service (350), and may also perform some population of the search indexes itself, such as by populating one or more of the indexes using information from the item processing component (306). Accordingly, the core search engine (302) can access one or more of the indexes (320, 360, and 370) when refining search results as dictated by one or more of the refiners (332). The core search engine (302) can then provide its refined results to the results processing component (310) for processing. For example, the results processing component (310) may include refinement indicators from the refiners (332) along with the refined results. The refined results can be sent to the client domain (316) through the client search API (312), where those refined results can be presented.

While an example architecture for a search service (300) has been described with reference to FIG. 3, many different variations of such architecture may be used. For example, the core search engine itself may populate the social index and the activities index. As another example, the indexes (320, 360, and 370) may be further divided into additional indexes, or further combined into fewer indexes.

### III. Smart Search Refinement Examples

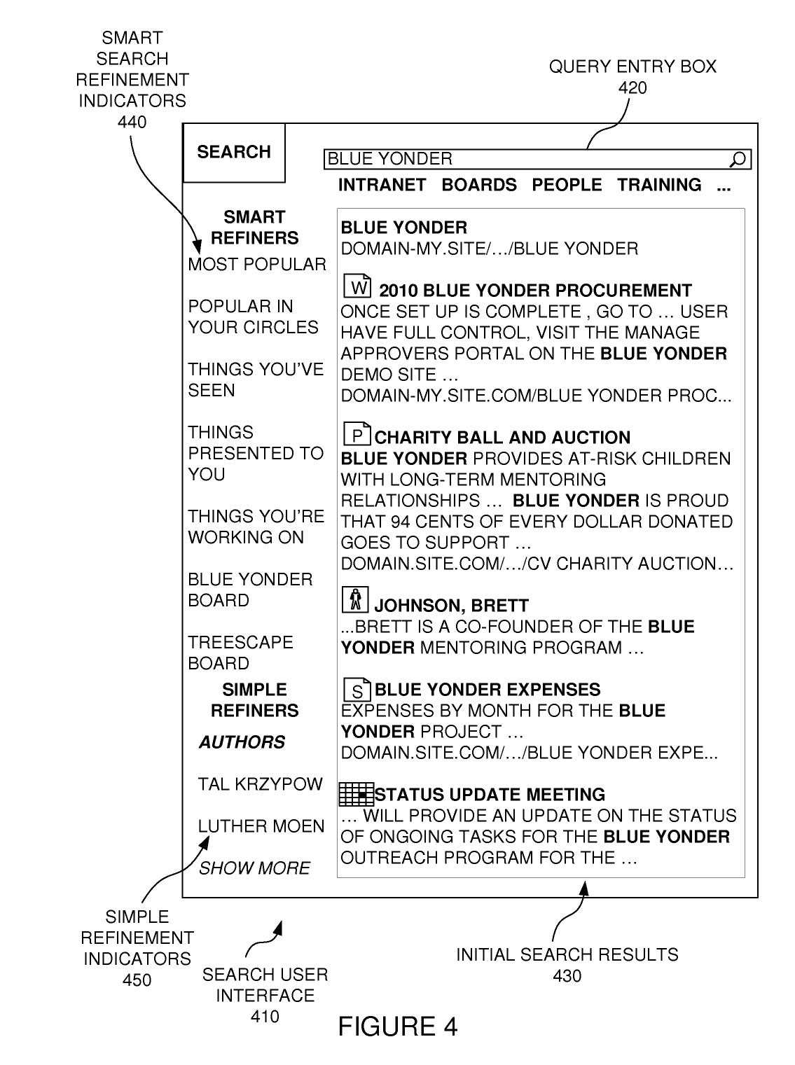

Examples of smart search refinement will now be discussed with reference to the search user interface illustrations of FIGS. 4-6. Referring to FIG. 4, a search user interface (410) can include a query entry box (420), wherein a search query can be entered by user input, such as by typing on a keyboard or touch screen, or by voice-to-text entry. In response to the entry of such a query, a search service can perform the requested search using the query and return initial search results (430), which can be displayed on the search user interface (410). Additionally, the search user interface (410) can include smart search refinement indicators (440), as well as simple search refinement indicators (450). The simple search refinement indicators (450) may be selected to perform a simple refinement on a single pre-defined search item aspect, such as an author aspect or a file type aspect (which may search for a specific file extension or group of file extensions, such as a group of spreadsheet file extensions). One of the simple search refinement indicators may be selected by user input to perform such a refinement.

Each smart search refinement indicator (440) can be selected by user input to invoke a smart refiner indicated by the corresponding smart search refinement indicator (440). Following are some examples:
MOST POPULAR: The documents with the most recent views, such as the most recent views in an entire company. This may return results from the initial results that have more than zero (or another limit) for an indexed searchable item property or field for recent views. This property may be a count of how many times each searchable item in the index has been accessed in a previous time period (e.g., the last 14 days). As with the other refiners discussed herein, different search systems may perform different techniques to obtain and use the information to perform this requested refinement.
POPULAR IN YOUR CIRCLES: This refiner may return results from the initial results that are the most viewed, commented, liked, etc. searchable items. This can be based on actions of the current user profile's (i.e., the user profile that is logged in to perform the current search session) closest colleagues, as determined by people that user profile has had many interactions with, and/or that the current user profile is close to in an organizational hierarchy, such as a hierarchy of a company.
THINGS YOU'VE SEEN: This refiner can return results from the initial results for searchable items that the current user profile has opened during a time period in the past (e.g., in the past 14 days). This may be tracked for multiple different programs, and may be for any of multiple different devices, device types, etc.
THINGS PRESENTED TO YOU: This refiner can return results from the initial results for searchable items that have been presented in meetings during a prior period of time (e.g., the past 14 days), where the current user profile is listed as an attendee.
THINGS YOU'RE WORKING ON: This refiner can return results from the initial results for searchable items that have been edited or changed by the current user profile.
CURATED BOARD: This refiner can return results from the initial results for searchable items listed in a list of specific searchable items. This list of searchable items can be created by user input from one or more user profiles.

These listed smart refiners are provided as examples. Many other different smart refiners are possible, and other refiners may be used in addition to or instead of these listed smart refiners.

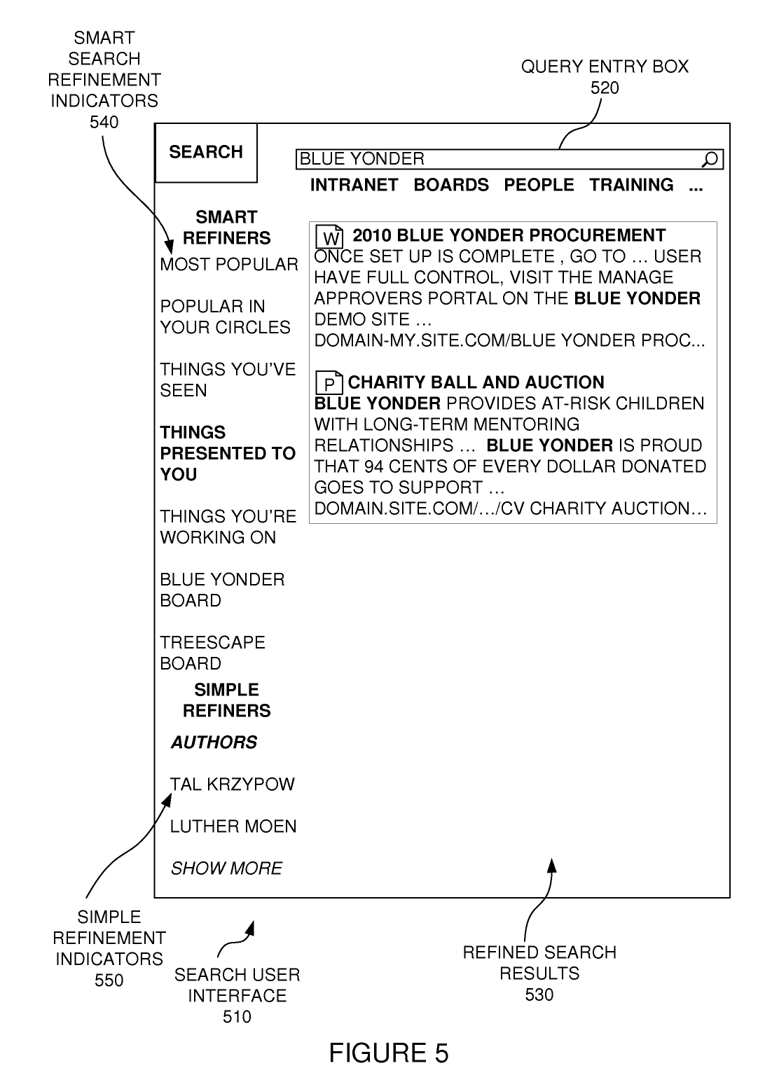

Referring now to FIG. 5 a search user interface (510) is illustrated. The search user interface (510) of FIG. 5 is similar to the search user interface (410) of FIG. 4 discussed above, including a query entry box (520). However, the search user interface (510) illustrates refined search results (530) returned and displayed after user input has selected the “THINGS PRESENTED TO YOU” smart search refinement indicator (540) from the list of smart search refinement indicators (440) of FIG. 4. The simple refinement indicators (550) may still be displayed. User input may be provided on the search user interface (510) to select a different refinement indicator, which can then result in refining the original query (“BLUE YONDER”) with that different refiner, rather than the “THINGS PRESENTED TO YOU” refiner.

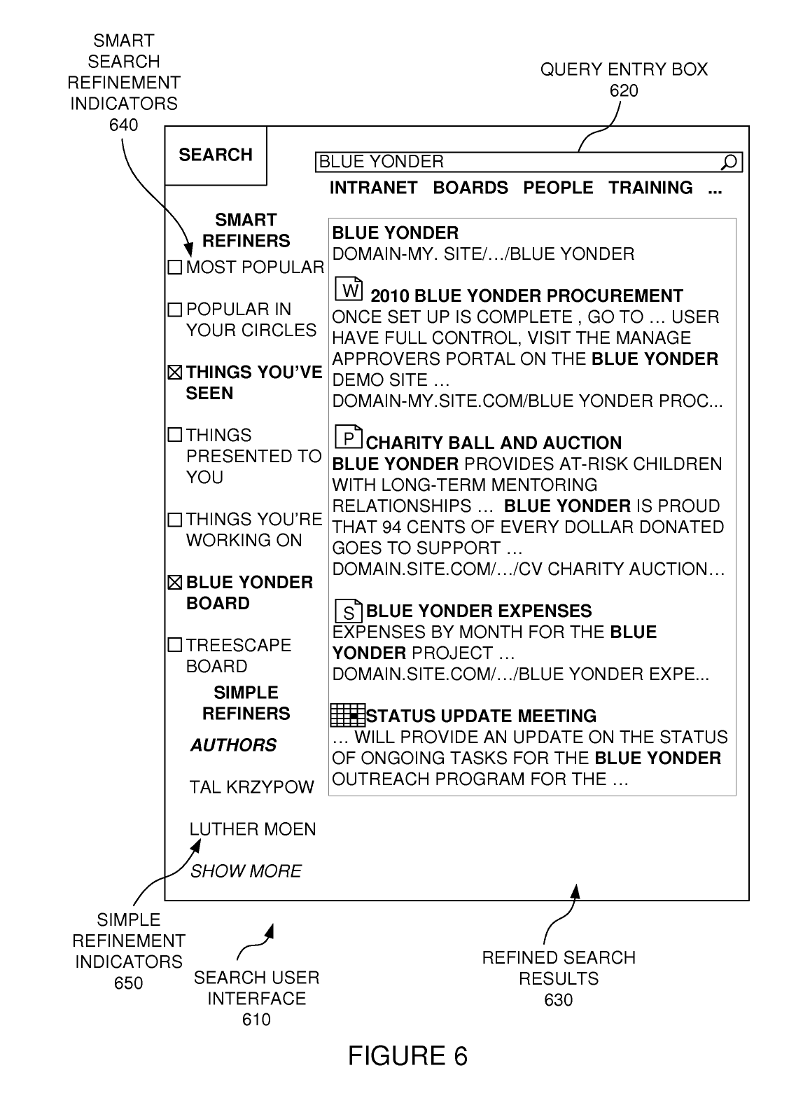

Referring now to FIG. 6, another search user interface (610) is illustrated with a query entry box (620), refined search results (630), smart search refinement indicators (640), and simple refinement indicators (650). In this example, the smart search refinement indicators (640) each includes a checkbox that can be selected by user input. This can allow user input to be provided selecting multiple smart search refinement indicators (640) at one time, which can invoke the corresponding refiners. The system may be set up to provide results that are the intersection of the initial search results and the refinement requirements. Where multiple smart search refinement indicators (640) are selected, the refinement requirements may be the intersection of the refiners corresponding to the selected smart search refinement indicators (640), or the union of the refiners corresponding to the selected smart search refinement indicators. In some examples, a user interface component may be provided to allow a user to select whether the refinement requirements are the union or the intersection of the selected refiners.

### IV. Smart Search Refinement Techniques

Several smart search refinement techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable storage media may have computer-executable instructions embodied thereon that, when executed by at least one processor, cause at least one processor to perform the technique. The techniques discussed below may be performed at least in part by hardware logic.

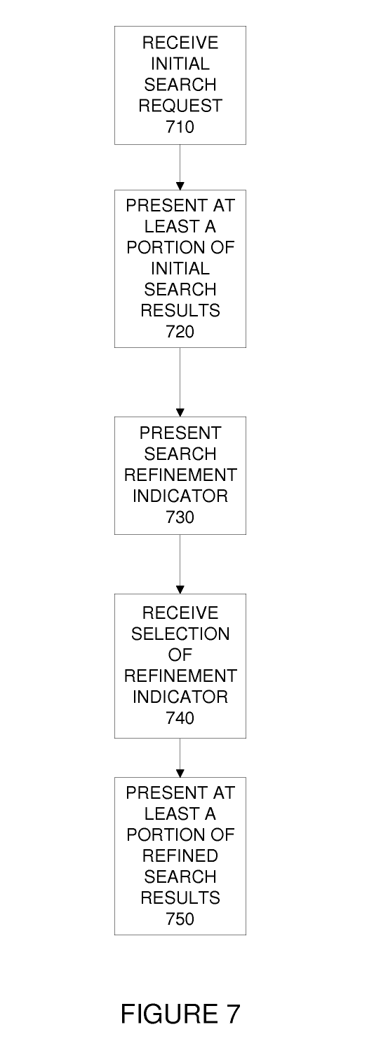

Referring to FIG. 7, a smart search refinement technique will be described. The technique can include receiving (710) an initial search request from a computer-readable user profile. For example, the initial search request may be received from user input on a device that is logged into a system using the user profile. At least a portion (e.g., the entire results set, a first page of multiple pages in the results set, or some other portion of the results set) of a set of initial search results can be presented (720) in response to receiving the initial search request. The initial search results can include representations of searchable items that are responsive to the initial search request, where each of the searchable items can be a computer-readable data structure.

Also in response to receiving (710) the initial search request, a search refinement indicator can be presented (730). User input can be received (740) from the user profile selecting the refinement indicator. In response to receiving (740) the user input from the user profile selecting the refinement indicator, at least a portion of a set of refined search results can be presented (750). The refined search results can be a subset of the initial search results representing searchable items that meet requirements comprising a set of pre-defined smart refinement requirements of the refinement indicator. The set of pre-defined smart refinement requirements can be selected from a group consisting of the following: a complex query requirement set, the complex query requirement set specifying requirements for multiple different aspects of a searchable item that are to be met for a corresponding searchable item representation to be included in the refined search results; a user action requirement set, the user action requirement set specifying at least one requirement for a user action set comprising one or more user actions on a searchable item, and the user action requirement set further specifying at least one relationship of the user action set to the user profile for a corresponding searchable item representation to be included in the refined search results (which may be a direct relationship such as where the user action set is performed at least in part by the user profile from which the search request is received; or an indirect relationship such as where the user action set is performed at least in part by a second user profile that has a social relationship with the user profile from which the search request is received, with the social relationship meeting a predetermined set of social relationship criteria); a user profile relationship requirement set specifying at least one requirement for one or more relationships (such as social relationships) between the user profile from which the search request is received and one or more other user profiles for one or more searchable item representations corresponding to one or more searchable items related to those one or more other user profiles to be included in the refined search results; an excluded item requirement set comprising one or more identifiers of one or more specific searchable items whose representations are to be excluded from the refined search results; an included item requirement set comprising one or more identifiers of one or more specific searchable items whose representations are to be included in the refined search results if representations of those specific searchable items are included in the initial search results; and combinations of the complex query requirement set, the user action requirement set, the user profile relationship requirement set, the excluded item requirement set, and the included item requirement set. Accordingly, the set of pre-defined smart refinements may be selected from a group consisting of combinations of two or more of the following: the complex query requirement set, the user action requirement set, the user profile relationship requirement set, the excluded item requirement set, and the included item requirement set, or the set of pre-defined smart refinement requirements may be any one of these.

The search refinement indicator may be termed a first search refinement indicator, the set of pre-defined smart refinement requirements may be termed a first set of pre-defined smart refinement requirements, and the refined search results may be termed initial refined search results. With these terms in mind for the sake of discussion and clarity, the technique may further include presenting a second search refinement indicator. In response to user input from the user profile selecting the second refinement indicator in addition to the selection of the first refinement indicator, further refined search results can be presented. The further refined search results can be a subset of the refined search results representing searchable items that meet requirements comprising a second set of pre-defined smart refinement requirements of the second refinement indicator in addition to the requirements of first refinement indicator. The second set of pre-defined smart refinement requirements can be different from the first set of pre-defined smart refinement requirements. The second set of pre-defined smart refinement requirements may also be selected from a group consisting of the following: the complex query requirement set, the user action requirement set; the user profile relationship requirement set; the excluded item requirement set; the included item requirement set; and combinations of the complex query requirement set, the user action requirement set, the user profile relationship requirement set, the excluded item requirement set, and the included item requirement set. The search results may be even further refined in this same manner with the use of additional search refinement indicators (a third search refinement, a fourth search refinement indicator, etc.).

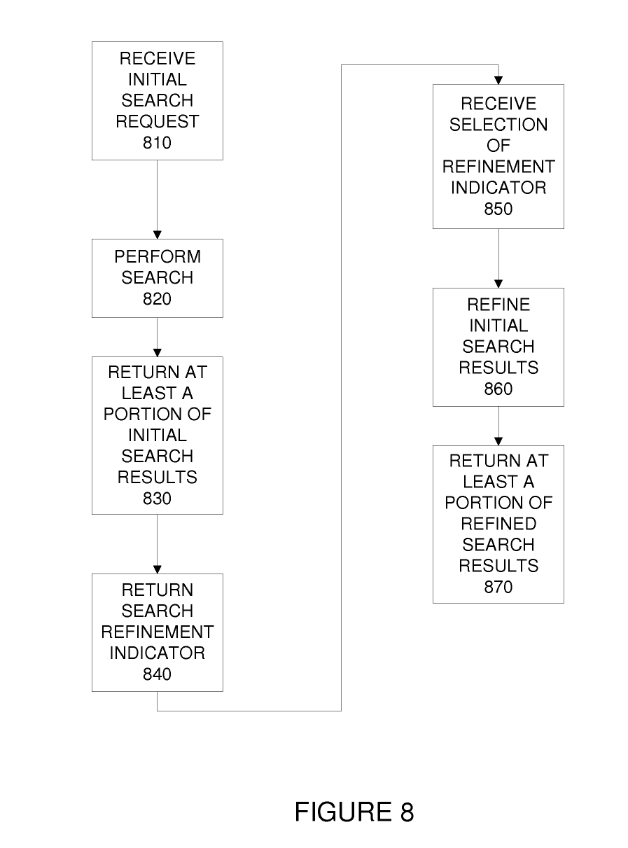

Referring now to FIG. 8, another technique for smart search refinement will be discussed. The technique can include receiving (810) an initial search request from a computer-readable user profile. A search can be performed (820) in response to the initial search request. At least a portion of a set of initial search results can be returned (830) in response to receiving the initial search request. The initial search results can include representations of searchable items that are responsive to the initial search requests and meet requirements of the initial search request. Each of the searchable items can be a computer-readable data structure.

In response to receiving (810) the initial search request, a search refinement indicator can also be returned (840). A selection of the refinement indicator can be received (850), and in response to receiving (850) the indicator, the initial search results can be refined (860) to produce a set of refined search results. Refining (860) the search results can include narrowing the search results to exclude results that fail to meet requirements comprising a set of pre-defined smart refinement requirements of the refinement indicator. The set of pre-defined smart refinement requirements can be selected from a group consisting of the following: a complex query requirement set, the complex query requirement set specifying requirements for multiple different aspects of a searchable item that are to be met for a corresponding searchable item representation to be included in the refined search results; a user action requirement set, the user action requirement set specifying at least one requirement for a user action set comprising one or more user actions on a searchable item, and the user action requirement set further specifying at least one relationship (which may be direct or indirect) of the user action set to the user profile for a corresponding searchable item representation to be included in the refined search results; user profile relationship requirement set that specifies at least one requirement comprising one or more relationships (such as social relationships) between the user profile from which the search request is received and one or more other user profiles for one or more searchable item representations corresponding to one or more searchable items related to those one or more other user profiles to be included in the refined search results; an excluded item requirement set comprising one or more identifiers of one or more specific searchable items whose representations are to be excluded from the refined search results; an included item requirement set comprising one or more identifiers of one or more specific searchable items whose representations are to be included in the refined search results if representations of those specific searchable items are included in the initial search results; and combinations of the complex query requirement set, the user action requirement set, the user profile relationship requirement set, the excluded item requirement set, and the included item requirement set. Also in response to receiving the selection of the refinement indicator, at least a portion of the set of refined search results can be returned (870). For example, such search results may be returned from a search service to a remote client computing machine from which the search request and the selections of FIG. 8 are received.

Refining (860) the initial search results can include accessing an activity index that relates activities to representations of searchable items and/or relates activities to user profiles. Refining (860) the initial search results can further include accessing a social index that relates user profiles to each other. For example, the activity index and the social index may be part of the same index, or they may be different indexes.

The technique of FIG. 8 may further include receiving user input specifying representations of specific searchable items to be entered in the included item requirement set and/or in the excluded item requirement set prior to receiving (810) the initial search request. Representations of specific searchable items may also be included in the corresponding included item requirement set and/or excluded item requirement set prior to receiving (810) the initial search request.

The technique of FIG. 8 may further include selecting a subset of refinement indicators comprising less than all of a set of available refinement indicators to return in response to receiving (810) the initial search request. The selection of the subset can include tailoring the subset to the initial search results. For example, selecting the subset may involve excluding one or more refinement indicators that do not sufficiently refine the initial search results and/or one or more refinement indicators that do not leave a sufficient number refined search results. For example, selection of the subset may involve selecting refinement indicators that produce refined search results that meet pre-defined specifications, such as refined search results that are in a specified range of numbers of search item representations and/or in a specified range of percentages of the initial search results.

The technique of FIG. 8 may further include returning with the search refinement indicator an indication of an extent to which the selection of the search refinement indicator will refine the initial search results. For example, the indication of the extent may indicate a percentage or range of percentages of the initial search results that will be included in the refined search results by the refiner indicated by that search refinement indicator, and/or a number of searchable item representation(s) that will be included in the refined search results by the refiner indicated by that search refinement indicator.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
receiving an initial search request from a computer-readable user profile;
presenting at least a portion of a set of initial search results in response to receiving the initial search request, the initial search results including representations of searchable items that are responsive to the initial search request, each of the searchable items being a computer-readable data structure;
presenting a search refinement indicator in response to receiving the initial search request; and
in response to a user input from the user profile selecting the refinement indicator, presenting at least a portion of a set of refined search results, the refined search results being a subset of the initial search results representing searchable items that meet requirements comprising a set of pre-defined smart refinement requirements of the refinement indicator, the set of pre-defined smart refinement requirements being selected from a group consisting of the following:
a complex query requirement set, the complex query requirement set specifying requirements for multiple different aspects of a searchable item that are to be met for a corresponding searchable item representation to be included in the refined search results;
a user action requirement set, the user action requirement set specifying at least one requirement for a user action set comprising one or more user actions on a searchable item, and the user action requirement set further specifying at least one relationship of the user action set to the user profile for a corresponding searchable item representation to be included in the refined search results;
a user profile relationship requirement set specifying at least one requirement for a user profile relationship set comprising one or more relationships between the user profile and one or more other user profiles for one or more searchable item representations corresponding to one or more searchable items related to those one or more other user profiles to be included in the refined search results;
an excluded item requirement set comprising one or more identifiers of one or more specific searchable items whose representations are to be excluded from the refined search results;
an included item requirement set comprising one or more identifiers of one or more specific searchable items whose representations are to be included in the refined search results if representations of those specific searchable items are included in the initial search results; and
combinations of the complex query requirement set, the user action requirement set, the user profile relationship requirement set, the excluded item requirement set, and the included item requirement set.

2. The method of claim 1, wherein the set of pre-defined smart refinement requirements is selected from a group consisting of combinations of two or more of the following: the complex query requirement set, the user action requirement set, the user profile relationship requirement set, the excluded item requirement set, and the included item requirement set.

3. The method of claim 1, wherein the set of pre-defined smart refinement requirements is the complex query requirement set.

4. The method of claim 1, wherein the set of pre-defined smart refinement requirements is the user action requirement set.

5. The method of claim 1, wherein the set of pre-defined smart refinement requirements is the excluded item requirement set.

6. The method of claim 1, wherein the set of pre-defined smart refinement requirements is the included item requirement set.

7. The method of claim 1, wherein the set of pre-defined smart refinement requirements is defined prior to the presenting of the refinement indicator.

8. The method of claim 1, wherein the search refinement indicator is a first search refinement indicator, the set of pre-defined smart refinement requirements is a first set of pre-defined smart refinement requirements, the refined search results are initial refined search results, and the method further comprises:
presenting a second search refinement indicator; and
in response to a user input from the user profile selecting the second refinement indicator in addition to the selection of the first refinement indicator, presenting further refined search results, the further refined search results being a subset of the refined search results representing searchable items that meet requirements comprising a second set of pre-defined smart refinement requirements of the second refinement indicator, the second set of pre-defined smart refinement requirements being different from the first set of pre-defined smart refinement requirements, and the second set of pre-defined smart refinement requirements being selected from a group consisting of the following: the complex query requirement set, the user action requirement set; the user profile relationship requirement set; the excluded item requirement set; the included item requirement set; and combinations of the complex query requirement set, the user action requirement set, the user profile relationship requirement set, the excluded item requirement set, the included item requirement set, and combinations thereof.

9. The method of claim 1, wherein the method is performed at least in part by hardware logic.

10. A computer system comprising:
at least one processor; and
memory comprising instructions stored thereon that when executed by at least one processor cause at least one processor to perform acts comprising:
receiving an initial search request from a computer-readable user profile;
performing a search in response to the initial search request;
returning at least a portion of a set of initial search results in response to receiving the initial search request, the initial search results including representations of searchable items that are responsive to the initial search request, each of the searchable items being a computer-readable data structure;
returning a search refinement indicator in response to receiving the initial search request;
in response to receiving a selection of the refinement indicator, refining the initial search results to produce a set of refined search results, refining the search results comprising narrowing the search results to exclude results that fail to meet requirements comprising a set of pre-defined smart refinement requirements of the refinement indicator, the set of pre-defined smart refinement requirements being selected from a group consisting of the following:
a complex query requirement set, the complex query requirement set specifying requirements for multiple different aspects of a searchable item that are to be met for a corresponding searchable item representation to be included in the refined search results;
a user action requirement set, the user action requirement set specifying at least one requirement for a user action set comprising one or more user actions on a searchable item, and the user action requirement set further specifying at least one relationship of the user action set to the user profile for a corresponding searchable item representation to be included in the refined search results;
a user profile relationship requirement set specifying at least one requirement for a user profile relationship set comprising one or more relationships between the user profile and one or more other user profiles for one or more searchable item representations corresponding to one or more searchable items related to those one or more other user profiles to be included in the refined search results;
an excluded item requirement set comprising one or more identifiers of one or more specific searchable items whose representations are to be excluded from the refined search results;
an included item requirement set comprising one or more identifiers of one or more specific searchable items whose representations are to be included in the refined search results if representations of those specific searchable items are included in the initial search results; and
combinations of the complex query requirement set, the user action requirement set, the user profile relationship requirement set, the excluded item requirement set, and the included item requirement set; and
in response to receiving the selection of the refinement indicator, returning at least a portion of the set of refined search results.

11. The computer system of claim 10, wherein the set of pre-defined smart refinement requirements is the user action requirement set and refining the initial search results comprises accessing an activity index that relates activities to representations of searchable items.

12. The computer system of claim 11, wherein the activity index relates activities to user profiles.

13. The computer system of claim 12, wherein refining the initial search results further comprises accessing a social index that relates user profiles to each other.

14. The computer system of claim 13, wherein the activity index and the social index are the same index.

15. The computer system of claim 13, wherein the activity index and the social index are different indexes.

16. The computer system of claim 10, wherein the set of pre-defined smart refinement requirements is the included item requirement set and wherein the acts further comprise: receiving user input specifying representations of specific searchable items to be entered in the included item requirement set prior to receiving the initial search request; and
entering the representations of specific searchable items in the included item requirement set prior to receiving the initial search request.

17. The computer system of claim 10, wherein the set of pre-defined smart refinement requirements is the excluded item requirement set and wherein the acts further comprise: receiving user input specifying representations of specific searchable items to be entered in the excluded item requirement set prior to receiving the initial search request; and entering the representations of specific searchable items in the excluded item requirement set prior to receiving the initial search request.

18. The computer system of claim 10, further comprising selecting a subset of refinement indicators comprising less than all of a set of available refinement indicators to return in response to receiving the initial search request, the selection of the subset comprising tailoring the subset to the initial search results.

19. The computer system of claim 10, wherein the acts further comprise returning with the search refinement indicator an indication of an extent to which selection of the search refinement indicator will refine the initial search results.

20. One or more computer-readable storage media having computer-executable instructions embodied thereon that, when executed by at least one processor, cause at least one processor to perform acts comprising:
receiving an initial search request from a computer-readable user profile;
performing a search in response to the initial search request;
returning at least a portion of a set of initial search results in response to receiving the initial search request, the initial search results including representations of searchable items that are responsive to the initial search request, each of the searchable items being a computer-readable data structure;
returning a search refinement indicator with the initial search results in response to receiving the initial search request;
in response to receiving a selection of the refinement indicator, refining the initial search results to produce a set of refined search results, refining the search results comprising narrowing the search results to exclude results that fail to meet requirements comprising a set of pre-defined smart refinement requirements of the refinement indicator, the set of pre-defined smart refinement requirements being a user action requirement set, the user action requirement set specifying at least one requirement for a user action set comprising one or more user actions on a searchable item, and the user action requirement set further specifying at least one relationship of the user action set to the user profile for a corresponding searchable item representation to be included in the refined search results, refining the initial search results comprising accessing an activity index that relates activities to representations of searchable items and that relates activities to user profiles, and refining the initial search results further comprising accessing a social index that relates user profiles to each other; and
in response to receiving the selection of the refinement indicator, returning at least a portion of the refined search results.
